(19) United States
(12) Patent Application Publication
(10) Pub. No.: US 2007/0299559 A1
(43) Pub. Date: Dec. 27, 2007

(54) Evaluating Visual Proto-objects for Robot Interaction

(75) Inventors: Herbert Janssen, Muhlheim (DE); Bram Bolder, Langen (DE)

Correspondence Address: FENWICK & WEST LLP, SILICON VALLEY CENTER, 801 CALIFORNIA STREET, MOUNTAIN VIEW, CA, 94041, US

(73) Assignee: HONDA RESEARCH INSTITUTE EUROPE GMBH, Offenbach/Main (DE)

(21) Appl. No.: 11/765,951

(22) Filed: Jun. 20, 2007

(30) Foreign Application Priority Data
Jun. 22, 2006 (EP) 06012899

(51) Int. Cl. G06F 19/00

(52) U.S. Cl. 700/259

(57) ABSTRACT

An interactive robot comprises visual sensors, manipulators and a computer. The computer is configured to generate proto-objects from output signals from the visual sensors and store the proto-objects in memory of the computer. The proto-objects represent blobs of interest in an input field of the visual sensors identified at least by a three dimensional position label. The computer also generates objects hypotheses representing a category of the object based on evaluation of the proto-objects with respect to different behavior-specific constraints; and determines a visual tracking movement of the visual sensor, a movement of a body of the robot or a movement of the manipulators based on the object hypotheses and at least one proto-object as a target.

### RELATED APPLICATIONS

This application is related to and claims priority to European Patent Application No. 06 012 899 filed on Jun. 22, 2006, entitled “Evaluating Visual Proto-Objects for Robot Interaction.”

### FIELD OF THE INVENTION

The present invention relates to robots having a number of degrees-of-freedom that enables the robots to carry out different movements, more specifically to interaction of a robot with its environment based on visual information.

### BACKGROUND OF THE INVENTION

Research on humanoid robots is increasingly focusing on interaction in complex environments, including autonomous decision making and complex coordinated behaviors.

Robots evaluate visual information, especially information obtained from stereo vision of the environment. Based on the evaluation, the behavior of the robots may be controlled.

### SUMMARY OF THE INVENTION

Embodiments of the present invention provide a system that uses definitions of visual target objects (e.g., elongated colored object) to implement the fundamental elements of architecture that is easily extendible to handle more long term targets. The perceptual information as proto-objects is stored in short-term sensory memory so that the perceptual information can be used both in raw form to visually track the proto-objects in three dimension or form stable object hypotheses needed for reaching and grasping the objects.

In one embodiment of the present invention, the behavior and movements are evaluated based on sensory information and internal predictions.

In one embodiment of the present invention, a motion control system may be driven by a wide range of possible target descriptions. The motion control system ensures smooth and well-coordinated whole body movements using a set of cost functions as null space criteria.

In one embodiment of the present invention, the perception system uses color and stereo based three dimension information to detect relevant visual stimuli and maintains this information as proto-objects in short-term sensory memory. This sensory memory is then used to derive targets for visual tracking and to form stable object hypotheses. Movement targets for reaching movements can be derived from the stable object hypotheses. A prediction based decision system selects the best movement strategy and executes the movement strategy in real time. The internal prediction as well as the executed movements uses an integrated control system that uses a flexible target description in task space in addition to cost-functions in null space to achieve well-coordinated and smooth whole body movements.

One embodiment of the present invention provides an interactive robot comprising visual sensors, manipulators, and a computer. The computer is designed to process output signals from the visual sensors in order to generate proto-objects to be stored in memory. The proto-objects represent blobs of interest in the input field of the visual sensors indicated by at least a three dimensional position label. The computer also forms object hypotheses as to the category of the object based on evaluation of the proto-objects with respect to different behavior-specific constraints. Further, the computer determines at least one of the following: a visual tracking movement of the visual sensor, a movement of a body of the robot, or a movement of the manipulators based on the hypotheses, and at least one proto-object as a target for a movement.

In one embodiment of the present invention, the blobs can be further represented by at least one of the following: size, orientation, time of sensing, and an accuracy label.

In one embodiment of the present invention, the movement of the manipulator comprises at least a grasping movement and a poking movement.

In one embodiment of the present invention, the computer is configured to consider only the proto-objects that were generated after a predetermined time.

In one embodiment of the present invention, at least one of the evaluation criteria for the proto-objects is their elongation.

In one embodiment of the present invention, at least one of the evaluation criteria for the proto-objects is their distance to a behavior-specific reference point.

In one embodiment of the present invention, at least one of the evaluation criteria for the proto-objects is their stability over time.

Embodiments of the present invention also provide a method for controlling an interactive robot comprising visual sensors, manipulators and a computer. In one embodiment, output signals from the visual sensors are processed to generate proto-objects representing blobs of interest in the input field of the visual sensors at least by a three dimension position label. The hypotheses as to the category of the object are formed by evaluating the proto-objects. Then at least a visual tracking movement of the visual sensing means, a movement of the body of the robot or a movement of the manipulation means are decided based on the hypotheses and at least one proto-object as a target for the movement.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present invention can be readily understood by considering the following detailed description in conjunction with the accompanying drawings.

FIG. 1 illustrates an overview of the distribution of work and the communication paths of a system, according to one embodiment of the present invention.

FIG. 2 illustrates transformation of coordinates of a stereo image acquisition system to parallel aligned axes, according to one embodiment of the present invention.

### DETAILED DESCRIPTION OF THE INVENTION

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

A preferred embodiment of the present invention is now described with reference to the figures where like reference numbers indicate identical or functionally similar elements.

Embodiments of the invention provide a system that uses a definition of visual target objects (e.g., elongated colored object) to implement the fundamental elements of architecture that is easily extended to handle more long-term targets.

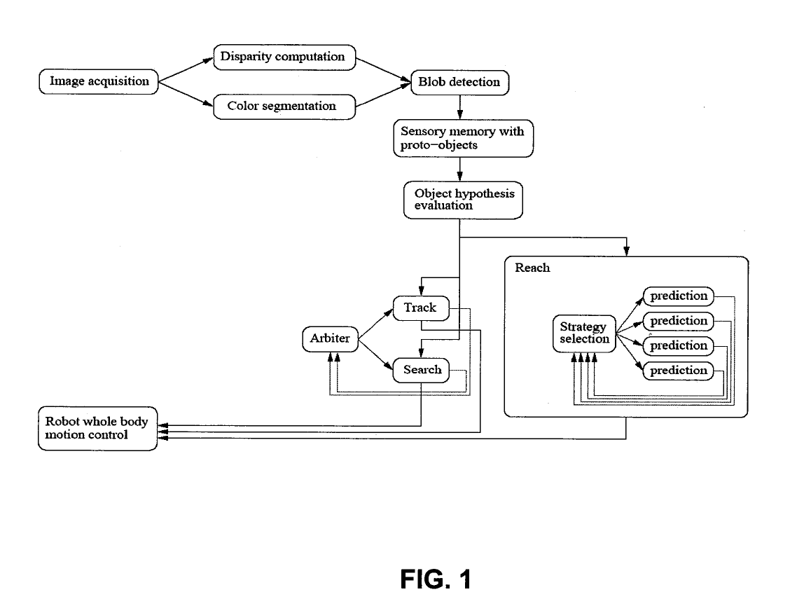

FIG. 1 illustrates elements of an embodiment of the present invention. The elements are: (a) storage of perceptual information as proto-objects in short-term sensory memory so that the perceptual information may be used both in raw form to visually track the proto-objects in three dimension or to form stable object hypotheses needed for reaching and grasping the objects; (b) decision mechanisms that evaluate behavioral and movement alternatives based on sensory information and internal prediction; and (c) a motion control system that can be driven by a wide range of possible target descriptions and that ensures smooth well-coordinated whole body movements using a set of cost functions as null space criteria.

In one embodiment, the perception system uses color and stereo information based on three dimension information to detect relevant visual stimuli. The color and stereo information is maintained as proto-objects in short-term sensory memory. This sensory memory is then used to derive targets for visual tracking and to form stable object hypotheses from which movement targets for reaching movements can be derived. A prediction based decision system selects the best movement strategy and executes it in real time. The internal prediction as well as the executed movements uses an integrated control system that uses a flexible target description in task space in addition to cost-functions in null space to achieve well-coordinated and smooth whole body movements.

A. System Overview

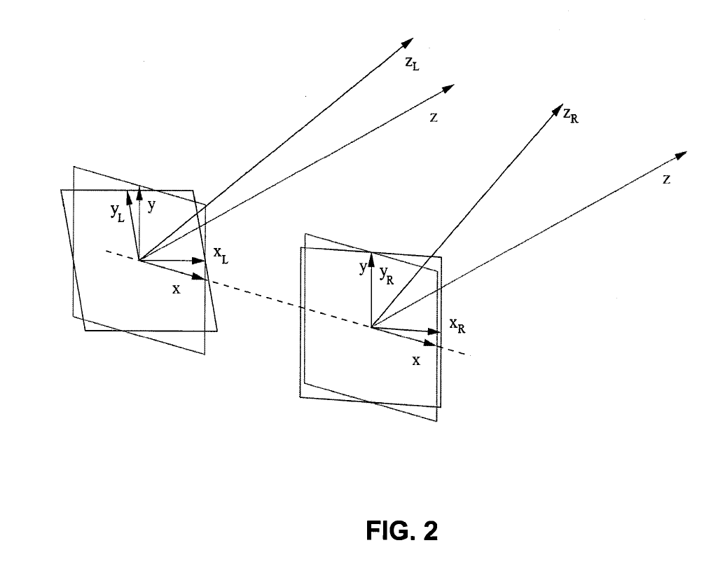

FIG. 1 illustrates the distribution of processing and communication paths of a computing unit designed for controlling an interactive autonomous robot, according to one embodiment of the present invention. Stereo color images (refer to FIG. 2) are continuously acquired by an image acquisition unit and then processed in two parallel pathways. The first pathway is a color segmentation unit designed for extracting regions of interest (hereinafter referred to as “blobs”).

FIG. 2 illustrates how the initially unaligned coordinates from a left camera (index “l”) and a right camera (index “r”) are transformed in order to align the coordinates in a parallel manner, according to one embodiment of the present invention.

The second pathway comprises a three dimension information extraction unit that can also be called a stereo computation block. The three dimension information extraction unit calculates the visual distance to the image acquisition unit for each pixel.

The results of the two pathways are combined to form proto-objects in the form of three dimension blobs that are stabilized over time in the short-term sensory memory.

In one embodiment, object hypotheses are generated by evaluating the current proto-objects stored in the sensory memory using defined criteria. These hypotheses can then be used by different behaviors as targets. The behaviors can be one or more of the following: (a) a searching or tracking behavior of the head; (b) a walking or resting behavior of the robot's legs; and (c) a reaching, grasping or poking behavior of the robot's arms.

In one embodiment, head targets (i.e., targets for a searching or tracking behavior of the head) are selected using a fitness function. The fitness function assesses the “fitness” of different behaviors in view of defined robot-related objectives and multiple objectives. The application of the fitness function results in a corresponding scalar fitness value.

Arm and body targets may be generated by selecting the internal prediction that is the most appropriate. The targets for controlling viewing direction, hand position and orientation, and leg motions are fed into a whole body movement system that generates motor commands.

The whole body movement system may be supported by a collision detection system based on kinematics to prevent the robot from damaging itself.

In one embodiment, the visual data and the robot postures are time labeled in order to incorporate the visual targets into the behavior. Mechanisms to access the robot posture at a given time are provided. This also requires time synchronization between the image acquisition and the motion subsystems.

Several components of the system will be discussed in detail below.

The vision and control processing is divided up into several smaller modules that interact in a data driven way in a real time environment.

B. Vision Overview

A chain of processing starts with newly acquired color stereo images. In one embodiment, these images are fed into the two independent parallel pathways using color and grey-scale images. The color processing consists of color segmentation of a color image that constructs a pixel-wise mask of color similarity. The pixel-wise mask of color similarity is then segmented into compact regions.

In one embodiment, the grey-scale images can be used to calculate image disparities between the left and right images in order to extract the three dimension information.

In one embodiment, to construct a three dimensional “proto-object” from the acquired vision data, each color segment is transformed into a blob (e.g., an oriented ellipse) using methods such as a two-dimensional Principal Component Analysis (PCA) of the pixel positions to estimate the principal orientation and respective sizes. Using the median of the disparities from the stereo calculations, this blob is converted to a three dimension representation. Blobs that are too small or have a depth profile outside a given range are disregarded.

In one embodiment, in order to stabilize this three dimensional blob in both time and space, the three dimensional blob is converted into world coordinates because the robot would likely have moved since the time of acquisition. To access the robot posture at the time of the image acquisition, the system uses time stamps of the vision data, and a posture buffer organized as a ring buffer that is constantly updated with the latest postures.

The three dimension blobs in world coordinates are called proto-objects because they are preliminary coarse representations of what could be physical objects. For the stabilization in time, the sensory memory compares the current list of proto-object measurements to the predictions of the existing proto-objects for the new time step. Using a metric of blob position, size, and orientation, the sensory memory either updates existing proto-objects, instantiates new proto-objects, or deletes proto-objects that have not been confirmed for a certain amount of time. Deleting the proto-objects insures that occluded objects and outliers do not remain in memory for an extended period.

In the following, the generation of object hypotheses from visual proto-object data is describe below in detail.

A proto-object as defined above may remain ambiguous and allow multiple methods of evaluation. However, each object hypothesis is based on just one specific method of evaluation of this data. In one embodiment of the present invention, the visual proto-object data is evaluated with respect to differences in such evaluation methods at the same time, for example, to track any type of segmentable object or region by head movement while grasping for one specific elongated object.

In one embodiment, pairs of color images labeled with the time of acquisition are used. These images are, as explained above with reference to FIG. 1, processed in two parallel paths: (a) the stereo disparity computation, and (b) the color segmentation.

1. Stereo Disparity Computation

In one embodiment, intensity image pairs are generated from the color image pairs. The images are rectified, that is, transformed so that the result corresponds to images captured with two pin-hole cameras with collinear image rows (refer to FIG. 2). The horizontal disparities between corresponding features in both images are computed if the features are sufficiently prominent.

2. Color Segmentation

In one embodiment, one color image of the pair is rectified as explained above and converted to the Hue, Luminance, Saturation (HLS) color space. All pixels are evaluated as to whether they lie in a certain volume in the HLS space. Then the result is subjected to morphological operations that eliminate small regions in a class of pixels. The resulting pixels that lie in the HLS space are grouped into regions that are contiguous in the image plane. The largest resulting groups that exceed a minimum size are selected for further processing.

For each of the groups from the color segmentation, the center area in the image plane xₚ, yₚ, and the median of the disparities d of all its pixels are computed. Also it is detected whether the group region touches the image boundaries; if so the data is labeled as inaccurate because parts of the real world object corresponding to the region are probably outside the field of view.

In one embodiment, the orientation of the principal axis ω and the standard deviations σₚ₁, σₚ₂ of the pixels in the image plane are computed for each group using a Principal Component Analysis (PCA) of the correlation matrix of the pixel positions.

Using the camera system geometry, the coordinates (xₚ, yₚ, d) and σₚ₁, σₚ₂ are transformed to the metric coordinates (x_{c}, y_{c}, z_{c}) and the metric standard deviations σ_{c1}, σ_{c2}.

In one embodiment, the robot posture and position at the time of the image capture are derived using the time label of the images, and used for transforming the position to world coordinates r̅_{b}=A (x_{c}, y_{c}, z_{c}) and the principal axis orientation ω to an orientation vector w̅ in world coordinates.

Thus, a blob can be defined as a set of data consisting of the time label, the position r̅_{b}, the orientation w̅, the standard deviations σ_{c1} and σ_{c2}, and the label indicating whether the data is accurate or inaccurate as described further above.

Storing of Proto-Objects in the Sensory Memory

The proto-objects are derived from blob data by taking the incoming blob data and comparing it to the contents of the sensory memory.

If the memory is empty, a proto-object is generated from blob data by simply assigning a unique identifier to the new proto-object and assigning the incoming blob data with the unique identifier.

If the sensory memory already contains one or more proto-objects, a prediction for each proto-object is generated as a blob data. This predicted blob data is based on all blob data that is contained in the proto-object and is generated for the current time.

Each incoming blob is either identified as an existing proto-object or a newly generated proto-object based on a minimum distance between the incoming blob and the predicted blob. All incoming blobs are assigned unique identifiers.

The metric for the distance computation is based on both Euclidean distance and relative rotation angle.

The inserted blob data is also modified so that the orientation distance of the new blob is always less than or equal to 90 degrees. This is possible because the blob orientation description is ambiguous with respect to 180 degree flips.

Every time new incoming blob data is generated by the processing, its time label is compared to the time labels of the blob data inside all proto-objects and all blob data older than a certain threshold is deleted. This is done even if the image processing does not find any blobs in the image pairs. If the proto-object does not contain any blob data, it is also deleted from the sensory memory.

The prediction needed for the comparison above is derived from the blob data inside the proto-object by a low pass filter on the position r̅, orientation w̅, and standard deviations σ_{c1}, σ_{c2}.

C. Behavior Selection

Object hypotheses are generated by evaluating the proto-objects stored in the sensory memory for certain criteria. For example, the elongation of the proto-objects can be chosen as an evaluation criterion for object hypotheses based on the ellipsoids' radii, elongated proto-objects are evaluated as behavior targets whereas more spherical proto-objects are disregarded. The presence of these elongated object hypotheses is a major criterion in the behavior selection mechanisms.

The two following selection mechanisms, for example, can be used to control the two main behavior groups.

The search and track behaviors can be selected based on a fitness function as described in T. Bergener, C. Bruckhoff, P. Dahm, H. Janssen, F. Joublin, R. Menzner, A. Steinhage, and W. von Seelen, “Complex behavior by means of dynamical systems for an anthropomorphic robot,” Neural Networks, 1999, which is incorporated by reference herein its entirety.

In one embodiment, the output of the sensory memory can be used, for example, to drive two different head behaviors: (a) searching for objects, and (b) gazing at or tracking objects or blobs.

Separate from these behaviors is provided a decision instance or “arbiter” that decides which behavior should be active at any time. The decision of the arbiter is solely based on a scalar value (“fitness value”) that is provided by simulating the behaviors. The fitness value describes how well a behavior can be executed at any time. In this case, tracking needs at least an inaccurate blob position to face the gaze direction, but may also use a full object hypothesis. Thus, the tracking behavior will output a fitness of one (1) if any blob or object is present, and a zero (0) if the blob or object is not present. The search behavior has no prerequisites at all; and thus, its fitness is fixed to one (1).

One embodiment of the invention provides, for extensibility, a competitive dynamic system similar to the one described in Bergener, C. Bruckhoff, P. Dahm, H. Janssen, F. Joublin, R. Menzner, A. Steinhage, and W. von Seelen, “Complex behavior by means of dynamical systems for an anthropomorphic robot,” Neural Networks, 1999. Thus, the arbiter uses a vector from the scalar fitness values resulting from the simulation of all behaviors as an input to a competition dynamics that calculates an activation value for each behavior. The competition dynamics uses a pre-specified inhibition matrix that can be used to encode directed inhibition (e.g., behavior A inhibits behavior B but not vice versa) to specify behavior prioritization and even behavior cycles. In this case, tracking can be prioritized to searching by using such directed inhibition.

In one embodiment, the search behavior is realized by means of a very low resolution (5 by 7) inhibition of return map with a simple relaxation dynamics. If the search behavior is active and new vision data is available it will increase the value of the current gaze direction in the map and select the lowest value in the map as the new gaze target. Additionally, the whole map is subject to a relaxation to zero (0) and a small additive noise.

This generates a visual search pattern with a random sequence of fixations that takes into account all visual information immediately and results in an efficient and fast finding of relevant objects. The size of the inhibition of return map is derived from the field of view of the cameras relative to the pan/tilt movement range. Higher resolutions will not change the searching significantly. The relaxation time constant is set in the second range so that motions of the robot that will effectively invalidate the inhibition map are not a problem.

In one embodiment, the tracking behavior is realized as a multi-tracking of three dimensional points. All relevant proto-objects and object hypotheses are taken into account and the pan/tilt angles for centering them in the field of view are calculated. Then a cost function with a trapezoidal shape in pan/tilt coordinates is used to find the pan/tilt angle that will keep the maximum number of objects in the effective field of view of the cameras. The pan/tilt angle is then sent as the pan/tilt command. Because the tracking behavior always uses the stabilized output of the sensory memory, the robot will still gaze in a certain direction even if a blob disappears for a short time. This significantly improves the performance of the overall system.

The other behaviors using hard coded criteria based on internal predictions will be discussed in a subsequent section.

Using these selection mechanisms, the system may search for elongated objects or track one or more of the objects. Simultaneously, the robot can reach for the elongated object using the most suitable arm with the palm aligned to the object's principal axis. If the object is too close or too far away, it will also choose the appropriate walking motion. If no target is available, the robot will stop walking and move its arms into a resting position.

The evaluations are also based on the blob data predictions of all proto-objects. The label of this prediction is set to “memorized” if the latest blob data in the proto-object is older than the prediction time. Otherwise, it is set to the label of the latest blob data in the proto-object.

A minimum criterion that is sufficient for the behavior of fixation and tracking is a blob labeled as inaccurate. Any blob labeled as inaccurate can be used for an approaching behavior. If more severe criteria such as stable values σ_{c1}, σ_{c2}, and a maximum distance are considered to avoid relying on insufficient vision data, stable object hypotheses may be extracted. To implement manipulation behaviors such as “poke balloon,” additional constraints can be added to the stable object hypotheses such as roughly spherical shape ((σc1-σc2)/σc1<threshold) and easiest execution of the behavior (for example, minimum distance to a behavior specific reference point for poking in front of the body). A behavior such as “power grasp object” will require a minimum elongation for grasp stability ((σc1-σc2)/σc1>threshold) and a suitable diameter (threshold<σc2<threshold).

E. Whole Body Motion and Prediction

In one embodiment, using the targets for the head, arms, and legs, the system generates motor commands using a whole body controller as described in M. Gienger, H. Janssen, and C. Goerick, “Task oriented whole body motion for humanoid robots,” in Humanoids, 2005, which is incorporated by reference herein its entirety.

The principle of the whole body motion is to use a flexible description of the task space and use the null space to meet several optimization criteria such as avoidance of joints limits and centre of mass shift compensation.

Since the computational costs for the whole body motion are low enough, it may be used for generating the robot motion directly as well as for simulating different behaviors on a time scale faster than real time using the fast convergence characteristics of the simulation.

Due to the low computational costs, the whole body motion is used to support the behavior selection of walking and arm movements. Four internal simulations continuously try to reach the target object from the current posture using both the left arm and the right arm while standing or walking. A metric is then used to select the best suited behavior that is then run at real time.

F. Collision Detection

In one embodiment, a real time collision detection algorithm is used in order to ensure safety of the robot during the operation. The collision detection uses an internal hierarchical description of the robot's body in terms of spheres and sphere-swept lines that is used together with the kinematics information to calculate the distances between the segments (limbs and body parts) of the robot. If any of these distances fall below a threshold, the high-level motion control will be disabled so that only the dynamic stabilization of the bipedal walking remains active.

The collision detection acts as a final safety measure and is not triggered during the normal operation of the robot. Additionally, simple collision avoidance limits the position of all movement targets so that, for example, target positions of a wrist of the robot are never generated inside or very close to the body of the robot.

Embodiments of the present invention can interact with its visual environment using both legs and arms.

In embodiments of the present invention, targets for the interaction are based on the visually extracted proto-objects. A control system allows the robot to increase its range of interaction, achieve multiple targets simultaneously, and avoid undesirable postures. Several different selection mechanisms are used to switch between different kinds of behaviors and posture at any time.

While particular embodiments and application of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. An interactive robot comprising a computer, visual sensors coupled to the computer, and manipulators coupled to the computer, the computer configured to:
generate proto-objects from output signals of the visual sensors, and store the proto-objects in memory of the computer, the proto-objects representing blobs of interest in an input field of the visual sensors identified at least by a three dimensional position label;
generate object hypotheses representing a category of the object based on evaluation of the proto-objects with respect to different behavior-specific constraints; and
determine a visual tracking movement of the visual sensor, a movement of a body of the robot or a movement of the manipulators based on the object hypotheses and at least one proto-object as a target for the visual tracking movement of the visual sensor, the movement of the body of the robot or the movement of the manipulators.

2. The robot of claim 1, wherein the blobs are further represented by at least parameters selected from the group consisting of size, orientation, time of sensing, and an accuracy label.

3. The robot of claim 1, wherein the movement of the manipulators comprises at least the movement selected from the group consisting of a grasping movement and a poking movement.

4. The robot of claim 1, wherein the computer is configured to consider proto-objects that have been generated after a predetermined time.

5. The robot of claim 1, wherein the evaluation considers elongation of the proto-objects.

6. The robot of claim 1, wherein the evaluation considers a distance between the proto-objects and a behavior-specific reference point.

7. The robot of claim 1, wherein the evaluation considers the stability of the proto-objects over time.

8. A method for controlling an interactive robot comprising a computer, visual sensors coupled to the computer, and manipulators coupled to the computer, the method comprising:
generating proto-objects from output signals of the visual sensors and storing the proto-objects in memory of the computer, the proto-objects representing blobs of interest in an input field of the visual sensors identified at least by a three dimensional position label;
generating object hypotheses representing a category of the object based on evaluation of the proto-objects with respect to different behavior-specific constraints; and
determining a visual tracking movement of the visual sensor, a movement of a body of the robot or a movement of the manipulators based on the object hypotheses and at least one proto-object as a target for the visual tracking movement of the visual sensor, the movement of the body of the robot or the movement of the manipulators.

9. The method of claim 8, further comprising:
discarding the proto-objects after lapse of a defined time period or after a movement of a body of the robot reaches a defined threshold value.

10. The method of claim 8, wherein the blobs are further represented by at least parameters selected from the group consisting of size, orientation, time of sensing, and an accuracy label.

11. The method of claim 8, wherein the movement of the manipulators comprises at least movements selected from the group consisting of a grasping movement and a poking movement.

12. The method of claim 8, wherein the computer is configured to consider proto-objects that have been generated after a predetermined time.

13. The method of claim 8, wherein the evaluation considers elongation of the proto-objects.

14. The method of claim 8, wherein the evaluation considers a distance between the proto-objects and a behavior-specific reference point.

15. The method of claim 8, wherein the evaluation considers the stability of the proto-objects over time.

16. A computer program product comprising a computer readable storage medium structured to store instructions executable by a processor, the instructions, when executed cause the processor to:
generate proto-objects from output signals of the visual sensors and store the proto-objects in memory of the computer, the proto-objects representing blobs of interest in an input field of the visual sensors identified at least by a three dimensional position label;
generate object hypotheses representing a category of the object based on evaluation of the proto-objects with respect to different behavior-specific constraints; and
determine a visual tracking movement of the visual sensor, a movement of a body of the robot or a movement of the manipulators based on the object hypotheses and at least one proto-object as a target for the visual tracking movement of the visual sensor, the movement of the body of the robot or the movement of the manipulators.
